(19) United States
(12) Patent Application Publication
(10) Pub. No.: US 2014/0229458 A1
(43) Pub. Date: Aug. 14, 2014

(54) Proof ID - search engine

(71) Applicant: Nelson C. Glasper, Newark, NJ (US)

(72) Inventor: Nelson C. Glasper, Newark, NJ (US)

(21) Appl. No.: 13/987,217

(22) Filed: Jun. 6, 2011

(51) Int. Cl. G06F 17/30

(52) U.S. Cl. CPC G06F 17/30864
USPC 707/706

(57) ABSTRACT

Driver's license and other documents include one or more machine-readable features, each conveying plural bits of information. These features are used in a variety of ways to increase driver identity, and/or to enhance functionality. In one embodiment, data encode on a driver's license used at police precinct Check-out driving license and other relates information link to the Motor Vehicles Services Database and obtain information by which the document, and its custodian, can be authenticated. In like fashion, a License can be used to authenticate a driver's and his/her valid driving licensing and driving history and other information under the Motor Vehicle Operator License Identification Act, and Freedom of Information Act. Such as a photo copy of driver's license and driving history, and other relate Information to public records. Sending driving license number from the web interface to remote driver license database over a network.

### CROSS-REFERENCE TO RELATED APPLICATIONS

Not Applicable

### STATEMENT REGARDING FEDERALLY SPONSORED RESEARCH AND DEVELOPMENT

Not Applicable.

### FIELD OF THE INVENTION

This invention relates to the field of identity verification, and more particularly to identity verification in real time in a face-face situation.

### DISCUSSION OF RELATED ART

### Summary of the Invention

### Brief Description of the Drawings

FIG. 1 is an exemplary flow chart illustrating the process of identity verification by accessing a driving license database in real time.

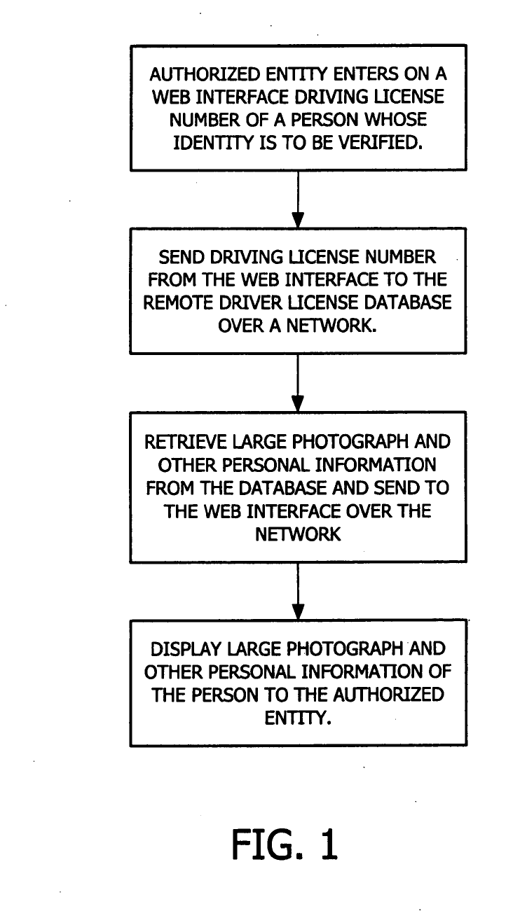

### DETAILED DESCRIPTION OF THE PREFERRED EMBODIMENT

While a particular form of the invention has been illustrated and described, it will be apparent that various modifications can be made without departing from the spirit and scope of the invention. Accordingly, it is not intended that the invention be limited, except as by the appended claims.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

We claim:

1. A method for verifying the identity of a person, comprising:
an authorized entity querying a remote driving license database maintained by a motor vehicle authority to verify the identity of a person, the entity using a web interface connected to the remote database over a network;
retrieving a large size photograph and other personal information about the person from the driving license database; and
displaying the large size photograph and the other personal information on the web interface to the authorized entity.

2. The method of claim 2, wherein the other personal information comprises the name and an address of the person whose identity is to be verified.

3. A method for verifying the identity of a person, comprising:
an authorized identity querying a remote personal information records database to verify the identity of a person, the entity using a web interface connected to the remote database over a network;
retrieving personal information about the person from the personal information records database; and
displaying the retrieved personal information on the web interface to the authorized entity.

4. The method of claim 3, wherein the retrieved personal information comprises a large size photograph.

5. The method of claim 3, wherein the retrieved personal information comprises the name and an address of the person.

6. A system for verifying the identity of a person, comprising:
a driving license database maintained by a motor vehicle authority;
a module for querying the driving license database to retrieve a large size photograph and other personal information of a person whose identity is to be verified, the querying of the database enabled on a web interface remotely connected to the database by a network; and
a module for displaying on the web interface the large size photograph and other personal information to an authorized entity.

7. The system of claim 7, wherein the other personal information comprises the name and an address of the person whose identity is to be verified.
